(19) United States
(12) Patent Application Publication
(10) Pub. No.: US 2017/0288513 A1
(43) Pub. Date: Oct. 5, 2017

(54) RING VARISTOR-BASED METHOD FOR REDUCING ELECTROMAGNETIC INTERFERENCE OF MOTOR

(71) Applicant: GUANGDONG ZHAOQING L&V CO. LTD., Guangdong (CN)

(72) Inventors: Chen FENG, Guangdong (CN); Yaoping LI, Guangdong (CN)

(21) Appl. No.: 15/508,821

(22) PCT Filed: Sep. 3, 2014
(86) PCT No.: PCT/CN2014/085824

§ 371 Date: Mar. 3, 2017

(51) Int. Cl. H02K 13/10; H02K 11/028; H01R 43/06; H01C 7/10

(52) U.S. Cl. CPC H02K 13/105; H01C 7/10; H02K 11/028; H01R 43/06

(57) ABSTRACT

A ring varistor-based method for reducing electromagnetic interference of a motor, a corresponding motor commutator, and the motor. The method comprises: forming a counter bore in an end portion of a motor commutator; and placing a ring varistor into the counter bore

### TECHNICAL FIELD

The present invention is related to the motor commutators, and to be more specific, it is related to a method for reducing the motor electromagnetic interference based on the ring-shaped varistor, and the corresponding motor commutator and motor.

### BACKGROUND OF THE TECHNOLOGY

It is well known that the ring-shaped varistor has been used to absorb the electromagnetic interference which may be generated by the instantaneous continuity between the commutator and the brush of the motor.

FIG. 1 shows the method of mounting the current ring-shaped varistor onto the commutator. As shown in the figure, the varistor has been soldered to the lug of the commutator. For the motors with relatively larger dimensions, the size of the ring-shaped varistor is also relatively larger, so, at the time when the varistor is soldered to the commutator lug, the size of the ring-shaped varistor needs to be made larger. When the size of ring-shaped varistor became larger, there will be the following disadvantageous points:

1. When the ring size of the varistor becomes larger, it will need to occupy more motor cover space, which will cause the interference with the end cover parts.

2. When the ring size of the varistor becomes larger, it will be easy to break, the requirements on the control of the production of varistor and the soldering installation process will be higher, and the cost of control will increase.

3. When the size becomes larger, more materials will be used, and the cost will become high.

For this reason, there is the demand in this industry on a kind of improved solution for mounting the ring-shaped varistor onto the commutator.

### CONTENT OF THE INVENTION

In one aspect of the present invention, it has provided a kind of method for reducing the motor electromagnetic interference based on the ring-shaped varistor, which will be composed of:

providing a counter bore at the end portion of a motor commutator; and

placing the ring-shaped varistor into the counter bore.

In another aspect of the present invention, it has provided a kind of motor commutator, wherein a counter bore will be provided at the end portion of this motor commutator and the ring-shaped varistor will be placed inside this counter bore.

In yet another aspect of the present invention, it has provided a kind of motor which will contain the above mentioned motor commutator.

### EXPLANATION OF THE ATTACHED FIGURES

FIG. 1 shows the method of mounting the current ring-shaped varistor onto the commutator;

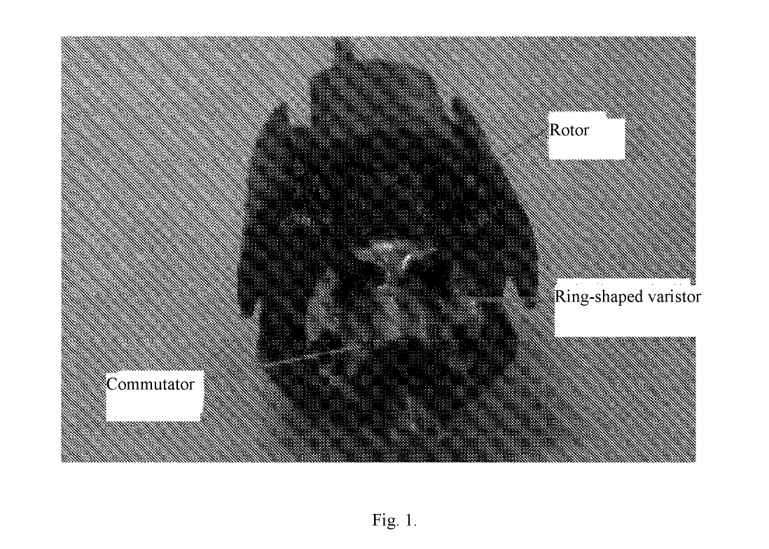

FIG. 2 shows the method of mounting the ring-shaped varistor onto the commutator in accordance with one embodiment of the present invention;

FIG. 3 shows the method of mounting the ring-shaped varistor onto the commutator in accordance with another embodiment of the present invention;

### SPECIFIC METHOD OF IMPLEMENTATION

In the following, the embodiments of the present invention will be explained with reference to the attached figures.

In the following description, a lot of specific details have been explained so as to enable a more complete understanding and implementation of the present invention by those skilled in this industry.

However, it is apparent to those skilled in this industry that, the implementation of the present invention may not have some of these specific details.

In addition, it should be understood that, the present invention will not be limited to the specific embodiments as described.

Instead, it can be considered as that the present invention may be implemented with any combination of the features and elements as described in the following, no matter whether they relate to different embodiments or not.

For this reason, the following aspects, features, embodiments and advantageous points will be used for the explanation only, and shall not be construed as an element or limitation of the claims, unless expressly stated in the section of claims.

In the present invention, the ring-shaped varistor will be mounted into the counter bore at the bottom end of the commutator to replace the conventional design of soldering the varistor onto the commutator lug, and in this say, the size of the varistor can be increased without increasing the EMC level, there will be no need to increase the size of the varistor, in addition, there will be no dimensional limit on the internal end cover space of the motor.

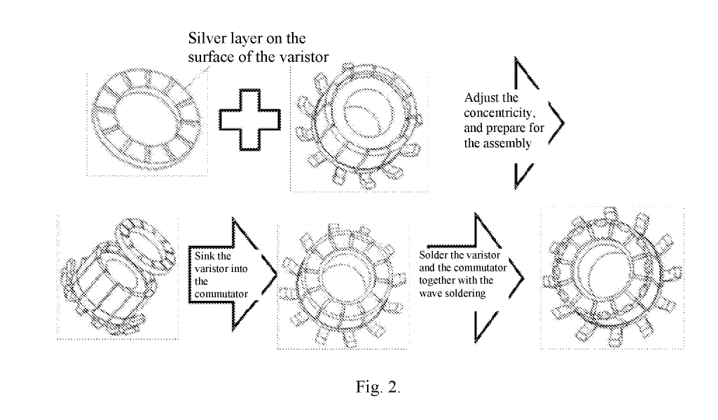

There are two embodiments of the present invention, and in the first embodiment, a counter bore will be formed at the end portion of the commutator, the varistor will be placed into this counter bore and be soldered (for example, wave soldering) onto the commutator segment. FIG. 2 shows a schematic view of such kind of embodiment.

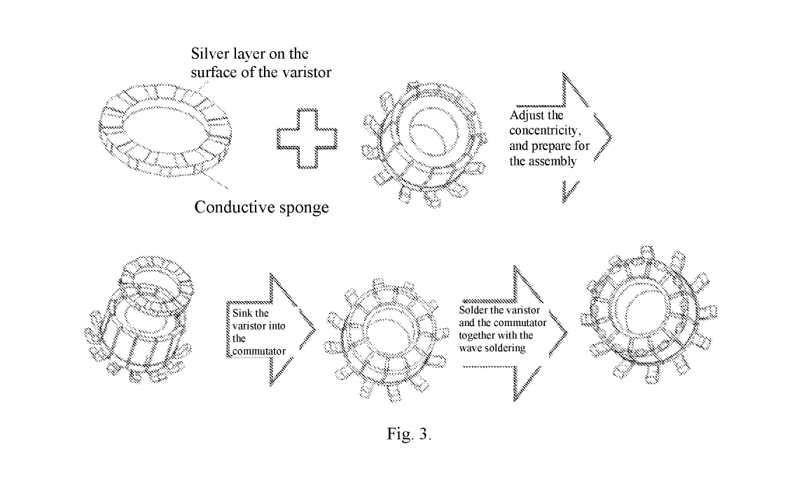

In the second embodiment, a layer of the conductive sponge will be glued to the silver layer of the varistor, the varistor which is glued with the conductive sponge will be placed into the counter bore, so as to make the conductive sponge be in contact with the commutator segment, and the varistor can also be soldered onto the commutator segment. FIG. 3 shows a schematic view of such kind of embodiment.

As what can be known to those skilled in this industry, the present invention actually has provided a kind of method for reducing the motor electromagnetic interference based on the ring-shaped varistor, a kind of motor commutator, and a kind of motor.

In one aspect of the present invention, it has provided a kind of method for reducing the motor electromagnetic interference based on the ring-shaped varistor, and this method will be composed of the following steps:

providing a counter bore at the end portion of a motor commutator; and

placing the ring-shaped varistor into the counter bore.

In accordance with some embodiments of the present invention, this method will be further composed of: soldering the ring-shaped varistor which is placed into the counter bore onto the commutator segment.

In accordance with some other embodiments of the present invention, this method will be further composed of:

gluing a layer of the conductive sponge on the silver layer of the ring-shaped varistor prior to placing the ring-shaped varistor into the counter bore, and making the conductive sponge and the commutator segment be in contact with each other at the time when the ring-shaped varistor which was glued with the conductive sponge is placed into the counter bore.

In another aspect of the present invention, it has provided a kind of motor commutator, wherein a counter bore will be provided at the end portion of this motor commutator and the ring-shaped varistor will be placed inside the counter bore.

In accordance with the embodiment of the present invention, the above mentioned ring-shaped varistor will be soldered onto the commutator segment.

In accordance with the embodiment of the present invention, a layer of the conductive sponge will be glued onto the silver layer of the above mentioned ring-shaped varistor, and the conductive sponge will be in contact with the commutator segment.

In yet another aspect of the present invention, it has provided a kind of motor which will contain the motor commutator in accordance with any one of the above mentioned embodiments of the present invention.

The advantageous points of the embodiments of the present invention will include at least one of the following items:

1. Because the varistor will be mounted into the counter bore at the end portion of the commutator, it will be possible to save the space, and it will be easy for welding.

2. There will be no need to increase the size of the varistor, so, it will be possible to save the materials (varistor material and solder) and the cost

3. Because the size change is not great, the requirements on the control of the production of the varistor will remain almost unchanged, and, the production control costs will not increase.

4. The varistor will be placed at the position of the counter bore, and due to the small size, it can be made thicker, the strength will be higher than the case of soldering onto the commutator hook.

5. It will be possible to effectively reduce the coil commutation voltage or the electromagnetic radiation which may be generated by the pulse voltage, and improve the EMC level.

Although the embodiments of the present invention have been explained in the above with reference to the attached figures, it will be understood by those skilled in this industry that the above description is the illustrative example only and is not intended to limit the present invention.

Various modifications and variations of the embodiments of the present invention may be made, but they will still fall under the spirit and scope of the present invention, and the scope of the present invention will be determined only by the attached section of claims.

1. A kind of method for reducing the motor electromagnetic interference, the method comprising:
providing a counter bore at the an end portion of a motor commutator; and
placing the a ring-shaped varistor into the counter bore.

2. The method of claim 1, further comprising:
soldering the ring-shaped varistor to the motor commutator.

3. The method of claim 1, further comprising:
gluing a layer of a conductive sponge on a silver layer of the ring-shaped varistor prior to placing the ring-shaped varistor into the counter bore.

4. A motor commutator having an end portion with a counter bore, the counter bore configured to receive a ring-shaped varistor.

5. The motor commutator of claim 4, wherein the ring-shaped varistor is configured to be soldered to the motor commutator.

6. The motor commutator of claim 4, wherein the ring-shaped varistor is configured for coupling to a layer of a conductive sponge, and the motor commutator is configured to contact the conductive sponge.

7. A motor having which the motor commutator claim 4.

8. The method of claim 3, wherein placing the ring-shaped varistor into the counter bore includes positioning the conductive sponge in contact with the motor commutator.
